(19) United States
(12) Patent Application Publication
(10) Pub. No.: US 2025/0225750 A1
(43) Pub. Date: Jul. 10, 2025

(54) APPARATUS AND METHOD FOR INPAINTING ADJUSTMENTS USING CAD GEOMETRY

(71) Applicant: CANON KABUSHIKI KAISHA, Tokyo (JP)

(72) Inventors: Rui Xu, Alhambra, CA (US); Xiwu Cao, Irvine, CA (US); Bradley Scott Denney, Irvine, CA (US); Floyd Albert Maseda, Tustin, CA (US)

(21) Appl. No.: 19/009,798

(22) Filed: Jan. 3, 2025

Related U.S. Application Data
(60) Provisional application No. 63/618,039, filed on Jan. 5, 2024.

(51) Int. Cl. G06T 19/20; G06T 5/77; G06T 7/73; G06T 15/40; G06T 19/00

(52) U.S. Cl. CPC G06T 19/20; G06T 5/77; G06T 7/74; G06T 7/75; G06T 15/40; G06T 19/006; G06T 2207/30201; G06T 2207/30204; G06T 2210/56; G06T 2219/024; G06T 2219/2004; G06T 2219/2016

(57) ABSTRACT

An image processing method and information processing apparatus is provided that executes an image processing method. The image processing method includes acquire an image from an image capture device, the image being captured live in real-time, acquire orientation information associated with a subject in the acquired image, using the acquired orientation information to obtain, from an image repository, a previously captured image of the subject in a similar orientation, generating a composite image by inpainting one or more landmarks from the obtained precapture image that are not present in the acquired live image based on a predetermined geometric representing the subject; and displaying, on a display device, the generated composite image.

### CROSS-REFERENCE TO RELATED APPLICATIONS

This application claims priority from U.S. Provisional Patent Application Ser. No. 63/618,039 filed on Jan. 5, 2024 which is incorporated herein by reference in its entirety.

### BACKGROUND

### Technical Field

The present disclosure relates generally to video image processing in a virtual reality environment.

### Description of Related Art

Given the progress that has been recently made in mixed reality, it is becoming practical to use a headset or Head Mounted Display (HMD) to join a virtual conference or a get-together meeting and be able to see each other with 3D faces in real-time. The need for these gatherings has been made more important because, in some scenarios such as a pandemic or other disease outbreaks, people cannot meet together in person.

Headsets are needed so we are able to see the 3D faces of each other using virtual and/or mixed reality. However, with the headset positioned on the face of a user, no one can really see the entire 3D face of others because the upper part of the face will be blocked by the headset. Therefore, to find a way to remove the headset and recover the blocked upper face region from the 3D faces is critical to the overall performance in virtual and/or mixed reality.

### SUMMARY

The present disclosure describes an image processing method and information processing apparatus that executes an image processing method. The image processing method includes acquire an image from an image capture device, the image being captured live in real-time, acquire orientation information associated with a subject in the acquired image, using the acquired orientation information to obtain, from an image repository, a previously captured image of the subject in a similar orientation, generating a composite image by inpainting one or more landmarks from the obtained precapture image that are not present in the acquired live image based on a predetermined geometric representing the subject; and displaying, on a display device, the generated composite image.

These and other objects, features, and advantages of the present disclosure will become apparent upon reading the following detailed description of exemplary embodiments of the present disclosure, when taken in conjunction with the appended drawings, and provided claims.

### BRIEF DESCRIPTION OF THE DRAWINGS

FIG. 1 illustrates a virtual reality capture and display system according to the present disclosure.

FIG. 2 shows an embodiment of the present disclosure.

FIG. 3 shows a virtual reality environment as rendered to a user according to the present disclosure.

FIG. 4 illustrates a block diagram of an exemplary system according to the present disclosure.

FIG. 5 is an algorithm for performing the operations associated with inpainting according to the present disclosure.

FIG. 6 is an algorithm for determining optimal CAD geometry according to the present disclosure.

FIG. 7 are exemplary candidate CAD geometries according to the present disclosure.

FIG. 8 depict exemplary outcomes of inpainting according to the present disclosure.

FIGS. 9A & 9B illustrates CAD geometry adjustment processing according to the present disclosure.

FIG. 10 is an algorithm detailing the processing associated with evaluating the inpainting performed on a live image according to the present disclosure.

FIG. 11 is an algorithm for obtaining an evaluation score according to the present disclosure.

FIG. 12 is an algorithm for obtaining an evaluation score according to the present disclosure.

Throughout the figures, the same reference numerals and characters, unless otherwise stated, are used to denote like features, elements, components or portions of the illustrated embodiments. Moreover, while the subject disclosure will now be described in detail with reference to the figures, it is done so in connection with the illustrative exemplary embodiments. It is intended that changes and modifications can be made to the described exemplary embodiments without departing from the true scope and spirit of the subject disclosure as defined by the appended claims.

### DESCRIPTION OF THE EMBODIMENTS

Exemplary embodiments of the present disclosure will be described in detail below with reference to the accompanying drawings. It is to be noted that the following exemplary embodiment is merely one example for implementing the present disclosure and can be appropriately modified or changed depending on individual constructions and various conditions of apparatuses to which the present disclosure is applied. Thus, the present disclosure is in no way limited to the following exemplary embodiment and, according to the Figures and embodiments described below, embodiments described can be applied/performed in situations other than the situations described below as examples. Further, where more than one embodiment is described, each embodiment can be combined with one another unless explicitly stated otherwise. This includes the ability to substitute various steps and functionality between embodiments as one skilled in the art would see fit.

### Section 1: Environment Overview

The present disclosure as shown hereinafter describes systems and methods for implementing virtual reality-based immersive calling.

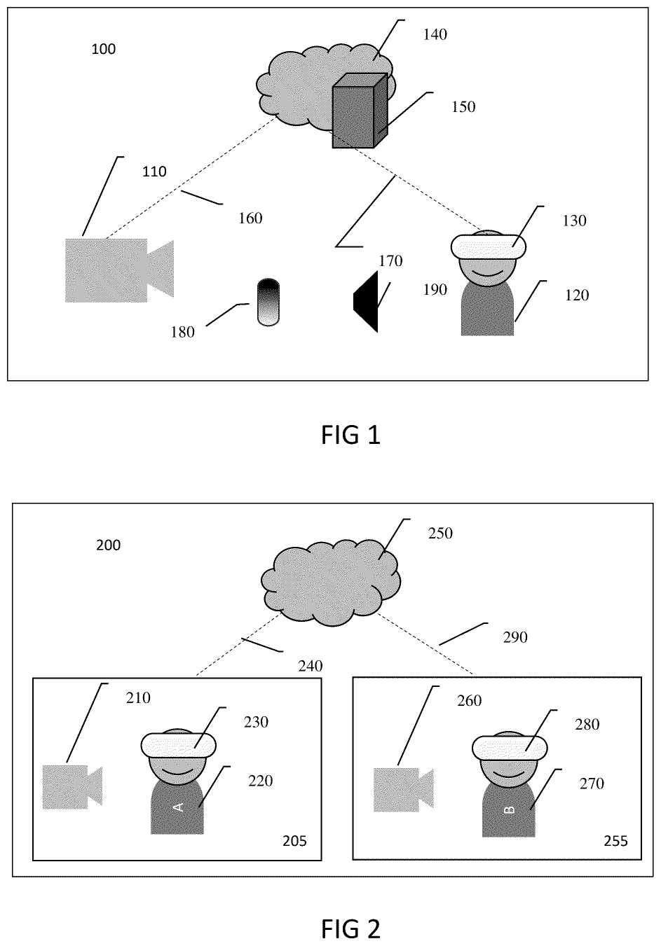

FIG. 1 shows a virtual reality capture and display system 100. The virtual reality capture system comprises a capture device 110. The capture device may be a camera with sensor and optics designed to capture 2D RGB images or video, for example. In one embodiment, the image capture device 110 is a smartphone that has front and rear facing cameras and which can display images captured thereby on a display screen thereof. Some embodiments use specialized optics that capture multiple images from disparate view-points such as a binocular view or a light-field camera. Some embodiments include one or more such cameras. In some embodiments the capture device may include a range sensor that effectively captures RGBD (Red, Green, Blue, Depth) images either directly or via the software/firmware fusion of multiple sensors such as an RGB sensor and a range sensor (e.g., a lidar system, or a point-cloud based depth sensor). The capture device may be connected via a network 160 to a local or remote (e.g., cloud based) system 150 and 140 respectively, hereafter referred to as the server 140. The capture device 110 is configured to communicate via the network connect 160 to the server 140 such that the capture device transmits a sequence of images (e.g., a video stream) to the server 140 for further processing.

Also, in FIG. 1, a user 120 of the system is shown. In the example embodiment the user 120 is wearing a Virtual Reality (VR) device 130 configured to transmit stereo video to the left and right eye of the user 120. As an example, the VR device may be a headset worn by the user. As used herein, the VR device and head mounted display (HMD) device may be used interchangeably. Other examples can include a stereoscopic display panel or any display device that would enable practice of the embodiments described in the present disclosure. The VR device is configured to receive incoming data from the server 140 via a second network 170. In some embodiments the network 170 may be the same physical network as network 160 although the data transmitted from the capture device 110 to the server 140 may be different than the data transmitted between the server 140 and the VR device 130. Some embodiments of the system do not include a VR device 130 as will be explained later. The system may also include a microphone 180 and a speaker/headphone device 190. In some embodiments the microphone and speaker device are part of the VR device 130.

FIG. 2 shows an embodiment of the system 200 with two users 220 and 270 in two respective user environments 205 and 255. In this example embodiment, each user 220 and 270 are equipped with a respective capture devices 210 and 260, respective VR devices 230 and 280, and are connected via respective networks 240 and 270 to a server 250. In some instances, only one user has a capture device 210 or 260, and the opposite user may only have a VR device. In this case, one user environment may be considered as a transmitter and the other user environment may be considered the receiver in terms of video capture. However, in embodiments with distinct transmitter and receiver roles, audio content may be transmitted and received by only the transmitter and receiver or by both, or even in reversed roles.

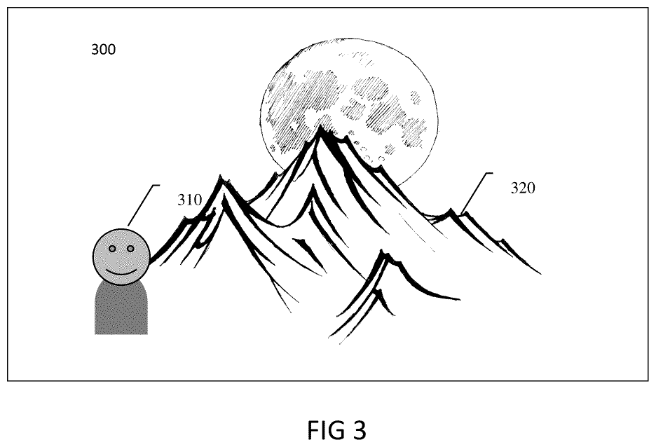

FIG. 3 shows a virtual reality environment 300 as rendered to a user. The environment includes a computer graphic model 320 of the virtual world with a computer graphic projection of a captured user 310. For example, the user 220 of FIG. 2, may see via the respective VR device 230, the virtual world 320 and a rendition 310 of the second user 270 of FIG. 2. In this example, the capture device 260 would capture images of user 270, process them on the server 250 and render them into the virtual reality environment 300.

In the example of FIG. 3, the user rendition 310 of user 270 of FIG. 2, shows the user without the respective VR device 280. The present disclosure sets forth a plurality of algorithms that, when executed, cause the display of user 270 to appear without the VR device 280 and as if they were captured naturally without wearing the VR device. Some embodiments show the user with the VR device 280. In other embodiments the user 270 does not use a wearable VR device 280. Furthermore, in some embodiments the captured images of user 270 capture a wearable VR device, but the processing of the user images remove the wearable VR device and replace it with the likeness of the users face.

Additionally, the addition of the user rendition 310 into the virtual reality environment 300 along with VR content 320 may include a lighting adjustment step to adjust the lighting of the captured and rendered user 310 to better match the VR content 320.

In the present disclosure, the first user 220 of FIG. 2, is shown via the respective VR device 230, the VR rendition 300 of FIG. 3. Thus, the first user 220, sees user 270 and the virtual environment content 320. Likewise, in some embodiments, the second user 270 of FIG. 2, will see in the same VR environment 320, but from a different view-point, e.g. the view-point of the virtual character rendition of 310 for example.

In order to achieve the immersive calling as described above, it is important to render each user within the VR environment as if they were not wearing the headset in which they are experiencing the VR content. The following describes the real-time processing performed that obtains images of a respective user in the real world while wearing a virtual reality device 130 also referred to hereinafter as the head mount display (HMD) device.

### Section 2: Hardware

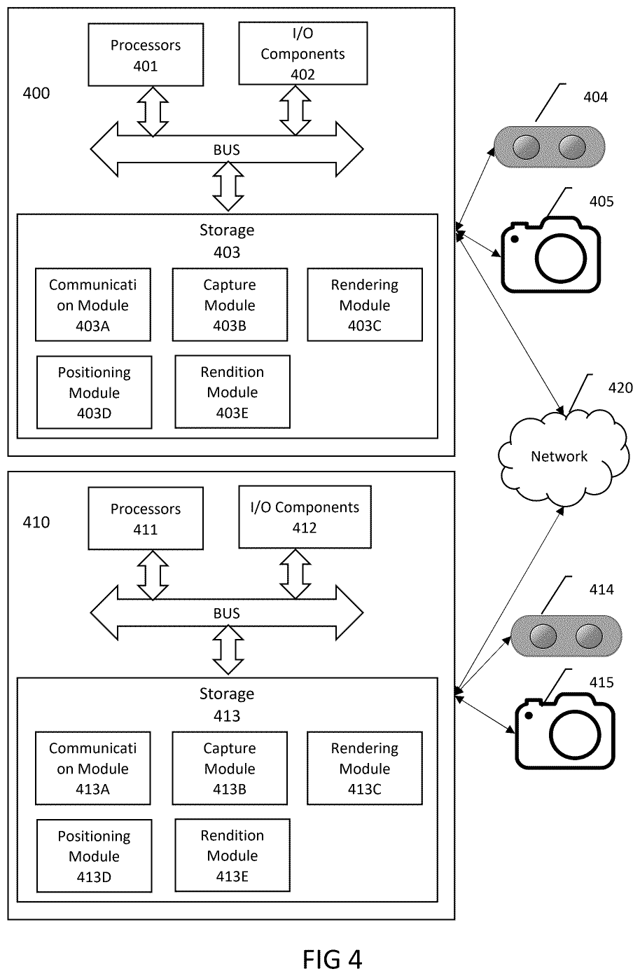

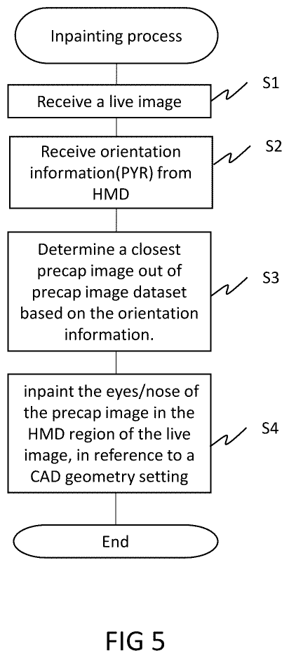

FIG. 4 illustrates an example embodiment of a system for virtual reality immersive calling system. The system includes two user environment systems 400 and 410, which are specially-configured computing devices; two respective virtual reality devices 404 and 414, and two respective image capture devices 405 and 415. In this embodiment, the two user environment systems 400 and 410 communicate via one or more networks 420, which may include a wired network, a wireless network, a LAN, a WAN, a MAN, and a PAN. Also, in some embodiments the devices communicate via other wired or wireless channels.

The two user environment systems 400 and 410 include one or more respective processors 401 and 411, one or more respective I/O components 402 and 412, and respective storage 403 and 413. Also, the hardware components of the two user environment systems 400 and 410 communicate via one or more buses or other electrical connections. Examples of buses include a universal serial bus (USB), an IEEE 1394 bus, a PCI bus, an Accelerated Graphics Port (AGP) bus, a Serial AT Attachment (SATA) bus, and a Small Computer System Interface (SCSI) bus.

The one or more processors 401 and 411 include one or more central processing units (CPUs), which may include one or more microprocessors (e.g., a single core microprocessor, a multi-core microprocessor); one or more graphics processing units (GPUs); one or more tensor processing units (TPUs); one or more application-specific integrated circuits (ASICs); one or more field-programmable-gate arrays (FPGAs); one or more digital signal processors (DSPs); or other electronic circuitry (e.g., other integrated circuits). The I/O components 402 and 412 include communication components (e.g., a graphics card, a network-interface controller) that communicate with the respective virtual reality devices 404 and 414, the respective capture devices 405 and 415, the network 420, and other input or output devices (not illustrated), which may include a keyboard, a mouse, a printing device, a touch screen, a light pen, an optical-storage device, a scanner, a microphone, a drive, and a game controller (e.g., a joystick, a gamepad).

The storages 403 and 413 include one or more computer-readable storage media. As used herein, a computer-readable storage medium includes an article of manufacture, for example a magnetic disk (e.g., a floppy disk, a hard disk), an optical disc (e.g., a CD, a DVD, a Blu-ray), a magneto-optical disk, magnetic tape, and semiconductor memory (e.g., a non-volatile memory card, flash memory, a solid-state drive, SRAM, DRAM, EPROM, EEPROM). The storages 403 and 413, which may include both ROM and RAM, can store computer-readable data or computer-executable instructions.

The two user environment systems 400 and 410 also include respective communication modules 403A and 413A, respective capture modules 403B and 413B, respective rendering module 403C and 413C, respective positioning module 403D and 413D, and respective user rendition modules 403E and 413E. A module includes logic, computer-readable data, or computer-executable instructions. In the embodiment shown in FIG. 4, the modules are implemented in software (e.g., Assembly, C, C++, C#, Java, BASIC, Perl, Visual Basic, Python, Swift). However, in some embodiments, the modules are implemented in hardware (e.g., customized circuitry) or, alternatively, a combination of software and hardware. When the modules are implemented, at least in part, in software, then the software can be stored in the storage 403 and 413. Also, in some embodiments, the two user environment systems 400 and 410 includes additional or fewer modules, the modules are combined into fewer modules, or the modules are divided into more modules. One environment system may be similar to the other or may be different in terms of the inclusion or organization of the modules.

The respective capture modules 403B and 413B include operations programed to carry out image capture as shown in 110 of FIGS. 1, 210 and 260 of FIG. 2. The respective rendering module 403C and 413C contain operations programed to carry out the functionality associated with rendering images that are captured to one or more users participating in the VR environment. The respective positioning module 403D and 413D contain operations programmed to carry out the process including identifying and determining position of each respective user in the VR environment. The respective user rendition modules 403E and 413E contains operations programmed to carry out user rendering as illustrated in the following figures described hereinbelow. The prior-training module 403F contains operations programmed to estimate the nature and type of images that were captured prior to participating in the VR environment that are used for the head mount display removal processing. In some embodiments the some modules are stored and executed on an intermediate system such as a cloud server. In other embodiments, the capture devices 405 and 415, respectively, include one or more modules stored in memory thereof that, when executed perform certain of the operations described hereinbelow.

### Section 3: Overview of HMD Removal Processing

As noted above, in view of the progress made in augmented virtual reality, it is becoming more common to enter into an immersive communication session in a VR environment where each user is in their own location wearing a headset or Head Mounted Display (HMD) to join together in virtual reality. However, HMD device has blocked the capability of achieving better user experience if a HMD removal is not applied since you won't see the full face of others while in VR and others are unable to see your full face.

Accordingly, the present disclosure advantageously provides a system and method that remove the HMD device from a 2D face image of a user that is wearing the HMD and participating in a VR environment. Removing the HMD from a 2D image of a user's face and not from the 3D object is advantageous because humans can perceive 3D effect from a 2D human image by inserting the 2D image into 3D environment.

More specifically, in a 3D virtual environment, the 3D effect of a human being can be perceived if this human figure is created in 3D or is created with the depth information. However, the 3D effect of a human figure is also perceptible even if we don't have the depth information. Here a captured 2D image of a human is placed into a 3D virtual environment. Despite not have the 3D depth information, the resulting 2D image is perceived as a 3D figure by human perception automatically filling the depth information. This is similar to the “filling-in” phenomenon for blind spots in human vision.

In augmented and/or virtual reality, users wear HMD device. At times, when entering a virtual reality environment or application, the user will be rendered as an avatar or facsimile of themselves in animated form but which does not represent an actual real-time captured image of themselves. The present disclosure remedies this deficiency by provide a real-time live view of a user in a physical space while they are experiencing a virtual environment. To allow the user to be captured and seen by others in the VR environment, an image capture device is camera positioned in front of the user to capture the user's images. However, because of the HMD device the user is wearing, others won't see the user's full face but only the lower part since the upper part is blocked by the HMD device.

To allow for full visibility of the face of the user being captured by the image capture device HMD removal processing is conducted to replace HMD region with an upper face portion of the image. It is a goal to replace the HMD region in an image of a user wearing the HMD device with one or more precaptured images of the user or artificially generated images to form a full face image of that user. In generating the full face image, the features of the face that are generally occluded when wearing the HMD are obtained and used in generating the full face image such that the eye region will be visible in the virtual reality environment. HMD removal is a critical component in any augmented or virtual reality environment because it improves visual perception HMD region is replaced with some reasonable images of the user that were previously captured.

The precaptured images that are used as replacement images during the HMD removal processing are images obtained using an image capture device such as a mobile phone camera or other camera whereby a user is directed, via instructions displayed on a display device to position themselves in an image capture region and move their face in certain ways and make different facial expressions. These precaptured images may be still or video image data and stored in a storage device. The precaptured images may be cataloged and labeled by the precapture application and stored in a database in association with user specific credentials (e.g. a user ID) so that one or more of these precaptured images can be retrieved and used as replacement images to replace the upper face portion to replace an upper portion of the face image that contains the HMD. This process will be further described hereinafter. In one embodiment, the precaptured images are user specific images obtained during a precapture process whereby a user uses a capture device, such as a mobile phone having a pre-capture application executing thereon. The precapture application displays messages on a display screen of the image capture device directing the user to move their face around in different orientations such that video of the users face at different positions and orientations are captured. From there, individual images of the user's face are extracted from the video and stored in a pre-capture database and labeled according image capture characteristics that identify the position and orientation of the face in a given image which can then be used later during HMD removal processing to generate the full face image of the user even though the user is being captured wearing an HMD device.

### Section 4: CAD Geometry Processing

The following processing reflects a particular aspect of the HMD removal processing that advantageously considers the way in which a user wears an HMD device and its position within the frame so that the HMD region to be replaced is correctly identified within the capture vide of the user and enables the user to wear the HMD in a way most comfortable to them. This improves the HMD removal application executing on a server in the cloud to more precisely identify the HMD region for replacement in a captured image. As such, the present disclosure addresses the problem whereby each user wears an HMD device in a slightly different manner causing it to be positioned differently. This makes it more difficult to consistently identify the HMD region in a video being captured. The following processing allows for this variation while improving the resulting identification and ultimate replacement of the HMD region in video being displayed to a user in a VR environment such that the user sees the individual subject to the HMD removal processing as if they were not wearing an HMD at all.

To achieve this improved identification of the HMD Region in a captured image, a CAD model of 3d point cloud data is used. The CAD model is a 3D point-cloud data-structure, which represents HMD and user-face 3D objects in a given image. CAD geometry provides information representing the scaling, rotation, and translation of HMD relative to the face of the user. This represents how user would prefer to wear an HMD relative to the face of the user when experiencing a VR application. CAD geometry can play a very helpful role in the HMD removal pipeline. This will be described with respect to FIG. 5. In S1, an incoming live image is received and in S2, orientation information is received from one or more sensors of the HMD. In S3, a determination if made to find, identify and select a candidate precapture user-specific image from an image repository having at least one precaptured image data set stored therein. The determination of the candidate precaptured image which represents a closest precaptured image out of the precaptured image dataset based on received PYR (Pitch, Yaw, Roll from HMD reading from S2). In S4, inpainting processing performed. The inpainting processing uses the eyes/nose of the determined precaptured image in the HMD region detected in the live image in reference to the CAD geometry setting. The output inpainted live image will be provided as input for further processing/computing modules such as landmark detection, landmark correction/refinement, color correction and others to complete the HMD removal process.

According to the present disclosure, determining or otherwise calculating adjustments to the CAD geometry setting improve the ability to identify the HMD region by taking into account user-specific positioning of the HMD in the images being captured in a live-capture process performed by an image capture device. It is these live captured images on which HMD removal processing is performed to generate removed images which are then provided to the other user in the VR environment so that the other user sees the live captured user as if the live captured user was not wearing the HMD device.

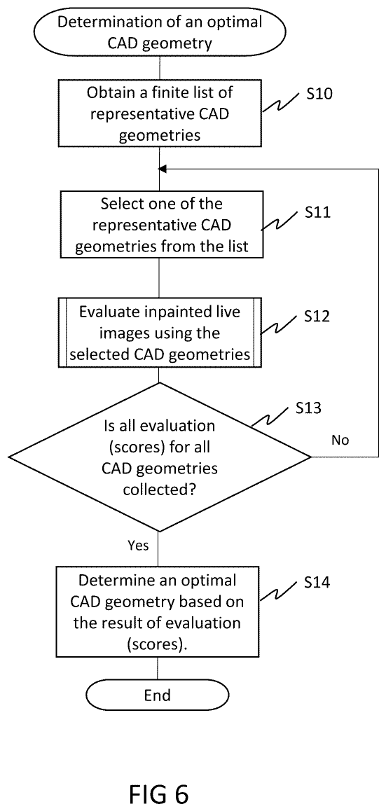

In one embodiment, a default CAD geometry setting is provided and used during HMD removal processing. This setting represents a likely manner that a user would wear an HMD device and thus represents a default CAD geometry. This default setting is active as the live capture processing begins based on the assumption that the HMD will be worn in a certain manner. As the live capture image processing proceeds, the application dynamically adjusts the default CAD geometry to reflect possible individual deviation from the default setting. In general, there may be two approaches to achieve this goal automatically. According to a first approach (1), the CAD geometry is directly inferred from the incoming live images through a machine learning model that has been trained with images of users wearing HMD devices and which can classify the different wearing positions amongst users of the HMD (e.g. a trainable AI model). According to a second approach (2), a finite list of representative CAD geometries is proposed and, from those proposed geometry settings, estimate the optimal CAD geometry based on the evaluation results of the inpainted live images that are output (S10-S14 of FIG. 6). The following description represents the algorithm for implementing the second approach. The algorithm is stored as computer executable instructions in one or more memories and executed by one or more processors.

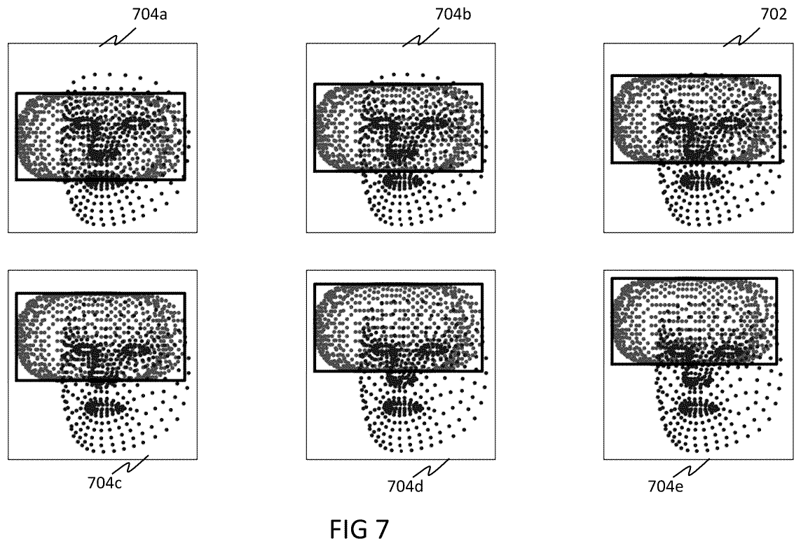

As shown in FIG. 7 a finite list of representative CAD geometries are obtained as in S10 in FIG. 6. As shown in FIG. 7, 702 (subplot in row 1, column 3) represents a default CAD geometry. Sublots 704a-704e reflect candidate CAD geometries each having predetermined deviations from the default CAD geometry 702. In one embodiment, the predetermined deviations are deviations in the Y direction from the default setting. The predetermined deviations being slight in the positive or negative Y direction are important because it is more likely that the change in wearing position will in that direction. Turning back to FIG. 7, an iterative process in steps S11-S13 are performed whereby each one of the CAD geometries illustrated in FIG. 7, are selected (S11) and inpainting processing is performed on the live image and an evaluation of the result of the inpainting processing using the selected CAD geometry is performed until evaluation scores are calculated for the live inpainted image being compared with each of the default CAD geometry 702 and all candidate CAD geometries 704a-704e.

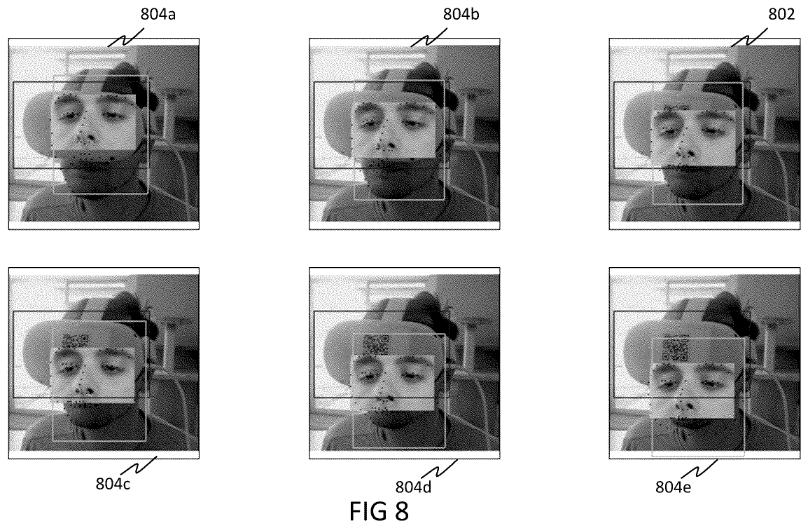

FIG. 8 depicts the outcome of inpainting processing using precaptured images representing the eyes/nose of a user in the HMD region using corresponding CAD geometry shown in a given row and column as described in the processing in S11-S13 of FIG. 6. As such, CAD geometry values 702 and 704a-704e represent an inpainting template which shows how the upper face is covered by the HMD_BBox in the live images 802 (corresponding to CAD geometry 702) and 804a-804e (corresponding to candidate CAD geometries 704a-704e). By improving the CAD geometry, the result is an improved output inpainted live image. It is these output inpainted live images (802 and 804a-804e) which will be evaluated in S12 of FIG. 6 to determine which candidate output image has a better quality score. As shown in FIGS. 7 and 8, the candidate CAD geometry point clouds illustrate some small deviations in the Y direction. However, this is described for purposes of example only and other different variations in any of X, Y and Z directions can be used to generate the candidate output images that are evaluated for quality score purposes.

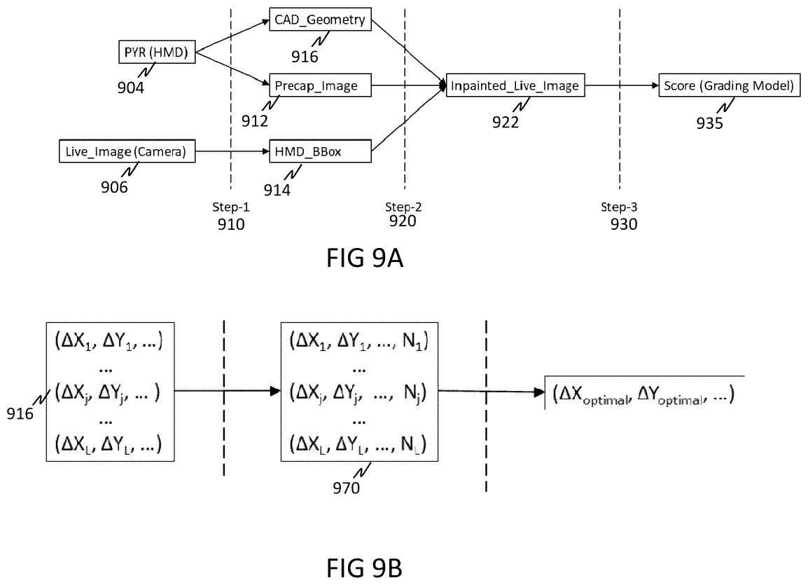

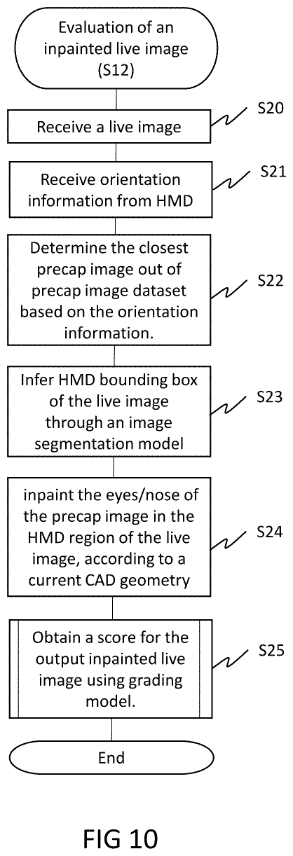

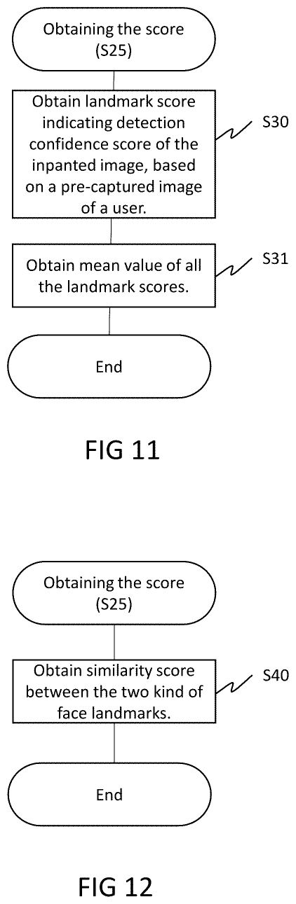

Turning now to exemplary processing operations performed to generate scored inpainted images (S12 in FIG. 6) will be described with respect to FIGS. 9 and 10 where FIG. 9 is a block diagram detailing the various steps and FIG. 10 is a flow diagram detailing the processing steps of the algorithm. FIG. 9 illustrates CAD geometry adjustment processing including three stages (e.g. steps). As input to the first stage 910, a live image 906 of a user wearing the HMD is captured by an image capture device such as a mobile phone and provided as input. Additionally, position/orientation data 904 are obtained. These values representing the PYR (Pitch, Yaw, Roll from HMD reading) are obtained and provided as input for further processing. The live image data 906 and the position/orientation data 904 correspond to the processing steps S20 and S21, respectively in FIG. 10. Once data 904 and 906 are obtained, they are used as input data for the first stage 910. The first stage includes, as described in step S22 of FIG. 10, using the PYR values 904 obtained in S21 as input query in performing a search of an image repository containing a plurality of precaptured images of the specific user not wearing the HMD and in various poses and orientations. This search determines the one or more images 912 from the precapture image data set stored in the image repository having PYR values substantially similar to the PYR values of the HMD, for a given time corresponding to the live captured image frame 906, that is currently being worn and is captured by the image capture device. This determination of a candidate precapatured image out of the precaptured image dataset is shown in S22 of FIG. 10. Additionally, in step S23 in FIG. 10 and in the first stage 910 of FIG. 9, the live capture image 906 as input to infer, using an image segmentation model (for example), a location of the HMD within the captured image frame and to generate a bounding box 914 around the HMD worn by the user (HMD_BBox) in the live image representing the HMD_Bbox. A plurality of CAD geometry values 916 (CAS_Geometry) which include a default CAD geometry and a plurality of candidate CAD geometry values are obtained (for example as shown in FIG. 7) from memory. In step S24 of FIG. 10 which corresponds to the second stage 920 in FIG. 9, one of the plurality of CAD geometry values 916 is set as a current CAD geometry used to generate an inpainted live image 922 using the eye/nose region from the precapture image 912 and inpainting that region within the bouding box HMD_Bbox 914 in the HMD region of the live image (FIG. 10, S24). The CAD geometry values 916 are shown in greater detail in 916 in FIG. 9B whereby each line illustrates a different CAD geometry such that the first line illustrates an exemplary default CAD geometry (e.g. 702 in FIG. 7) where each X1 and Y1 are the default X and Y and j represents a respective predetermined shift from default X and Y and L represents an integer corresponding to the total number of candidate CAD geometries each having a different shift j.

Each live inpainted image 922 that corresponds to respective CAD geometries 916 are provided as input to the third stage 930 in FIG. 9 on which evaluation processing is performed as in S25 in FIG. 10. The evaluation processing in S25 uses the grading model to evaluate each inpainted live image that corresponds to each of the CAD geometries and obtain an evaluation score 935. In one embodiment, as shown in FIG. 12, the grading model and its associated output is a trained machine learning model (e.g. a neural network, CNN or the like) that receives, input is an inpainted image containing eyes/nose, and outputs, as a return in S30, detection results (locations of landmarks [X, Y, Z] as well as confidence-scores of landmarks, typically ranging between 0 and 1). These confidence-scores, having values higher the better, are used as the criterion or metric. In another embodiment, the output of the trained machine learning model is used to compare derived landmarks [X, Y, Z] (of in-painted image) with ground-truth landmarks [X, Y, Z] (of pre-captured image, which are saved as user-specific data in database). Here, a similarity metric is used as criterion indicating how close these values are between two sets of coordinates whereby a similarity measure between two data points can be Euclidean distance (or variants) such that values that are smaller indicate a higher grade and closer in similarity.

For single incoming live image, we can repeat this process for all the proposed CAD geometries and collect their scores. Then, the optimal CAD geometry is expected to be the one with the highest score (S14). As illustrated in FIG. 9B, the processing is performed for a finite number (N=N₁+Nⱼ+ . . . +N_{L}) of incoming live images to gather their data or distribution (N₁, Nⱼ, . . . , N_{L}). Then, in one embodiment, a polynomial regression model is used to estimate the optimal CAD geometry, where Nⱼ can be interpreted as frequency or probability. There are L CAD geometries (parametrized by X, Y) and N incoming live images. Through the grading model 935 in FIG. 9A, the CAD geometry j get Nⱼ votes/wins. The CAD geometry with most votes may be determined as the optimal parameter. In another embodiment, an optimal parameter is estimated using regression/fitting method. For example, X_Optimal=(N_1*X_1+ . . . +N_L*X_L)/N, where distribution (N_1, . . . , N_L) representing a normal or gaussian distribution, and optimal value is expected to be mean value. This processing is reflected in FIGS. 12 and 13 which describe different algorithms for obtaining and using scores to determining which is the ideal CAD geometry to be used for actual inpainting processing. This is illustrated in 970 of FIG. 9B where each line corresponds to a respective CAD geometry that is determined to be the best fit the most number of times over a series of individual incoming live images that have been inpainted using all candidate CAD geometries.

Turning to FIG. 12, an output inpainted live image corresponding to a given CAD geometry is provided as input to a face landmark detection model to obtain both landmark coordinates and scores as in step S30. A landmark score typically ranges from 0 to 1 indicating detection confidence level of a particular landmark or a set of landmarks. In step S31, a mean value of all the landmark scores are used to evaluate the inpainted live image. Alternatively, a weighted mean value of all the landmark score may be used to evaluate the inpainted live image. Respective weights may be assigned to each kind of landmark (eye/nose/mouth/chin etc.) and not all landmarks detected in the image are required to be used as landmark scores. In one embodiment, because there are a set of precaptured images of a specific user not wearing an HMD, the face landmarks obtained from the precaptured image dataset can be considered as ground truth. Since a pre-captured image of the same user is used as ground truth, the high detection confidence level means better inpainting of the face landmarks.

Turning to FIG. 13, which provides an alternative evaluation processing, the inpainted live image is evaluated by checking the similarity score between the two kind of face landmarks as in step S40. In one embodiment, a mean value or a weighted mean value of a plurality of similarity sores may be used to evaluate the inpainted image. The plurality of similarity scores may be similarity scores of a multiple sets of two kind of face landmarks (for example, a similarity scores between nose and mouth and a similarity scores between eyes and nose.) The CAD geometry setting that can result in the highest score (e.g. the smallest difference) will be considered as the optimal one for the current HMD removal process.

As described hereinabove, the present disclosure describes an image processing method and information processing apparatus that executes an image processing method. The image processing method includes acquire an image from an image capture device, the image being captured live in real-time, acquire orientation information associated with a subject in the acquired image, using the acquired orientation information to obtain, from an image repository, a previously captured image of the subject in a similar orientation, generating a composite image by inpainting one or more landmarks from the obtained precapture image that are not present in the acquired live image based on a predetermined geometric representing the subject; and displaying, on a display device, the generated composite image.

In some embodiments, displaying includes providing the generated composite image to a remote user wearing a head mount display and causing the composite image to be displayed in a virtual reality environment and visible on a screen of the head mount display device.

In other embodiments, the subject in the acquired image is wearing a head mount display device that occludes at least an upper region of a face and further includes generating the composite image by using, an upper region of a face in the obtained precaptured image and inpainting the live captured image.

In another embodiment, the geometric representation is a three dimensional point cloud data of the subject in the live captured image wearing a head mount display device. Additionally, the predetermined geometric representation is a three dimensional point cloud including a plurality of point in three dimensional space of a head of the subject wearing an head mount display device. In further embodiments, the predetermined geometric representation of the subject includes information associated with one or more of scaling, rotation and translation of a head mount display being worn by the subject in the live captured image.

In another embodiment, the image processing method includes selecting the predetermined geometric representation from a candidate set of geometric representation of the subject.

In further embodiments, the image processing method also includes updating the predetermined geometric representation of the subject for a subsequently acquired live captured image based on variation of a position of an object being worn by the subject in the acquired live capture image.

Other embodiments of the image processing method include providing the acquired live capture image to a trained machine learning model that has been trained to identify positions of a predetermined object being worn by a user in an image, generating a similarity score by evaluating a position change of the predetermined object between the live captured image and a next live captured image, and determining, based on the generated similarity scored whether to continue to use the predetermined geometric representation or update the geometric representation with a different geometric representation selected from a set of candidate geometric representations.

In another embodiment, the image processing method includes determining the predetermined geometric representation by obtaining a finite list of geometric representations of a subject wearing an object that occludes at least a portion of the subject, selecting a plurality of geometric representation of the subject wearing the object, perform inpainting on the live captured image whereby landmarks from a precaptured image having substantially similar orientation and from a region being occluded by the object are inserted into the live captured image, evaluate the inpainted live image using the obtained finite list to determine a similarity score; and select, as the predetermined geometric representation, the geometric representation having a closet similarity score.

The present disclosure includes an information processing apparatus comprising one or more memories storing instructions; and one or more processors that, upon execution of the stored instructions, are configured to execute an image processing method according to any embodiment of the present disclosure.

The present disclosure includes a non-transitory computer readable storage medium storing instructions that, when executed by one or more processors, configured an information processing apparatus to executed an image processing method according to any of the embodiments of the present disclosure.

According to the present disclosure, a system is provided and includes a head mount display device configured to be worn by a subject; an image capture device configured to capture real time images of the subject wearing the head mount display device; and an apparatus configured to execute a method according to any embodiment of the present disclosure.

At least some of the above-described devices, systems, and methods can be implemented, at least in part, by providing one or more computer-readable media that contain computer-executable instructions for realizing the above-described operations to one or more computing devices that are configured to read and execute the computer-executable instructions. The systems or devices perform the operations of the above-described embodiments when executing the computer-executable instructions. Also, an operating system on the one or more systems or devices may implement at least some of the operations of the above-described embodiments.

Furthermore, some embodiments use one or more functional units to implement the above-described devices, systems, and methods. The functional units may be implemented in only hardware (e.g., customized circuitry) or in a combination of software and hardware (e.g., a microprocessor that executes software).

Additionally, some embodiments of the devices, systems, and methods combine features from two or more of the embodiments that are described herein. Also, as used herein, the conjunction “or” generally refers to an inclusive “or,” though “or” may refer to an exclusive “or” if expressly indicated or if the context indicates that the “or” must be an exclusive “or.”

While the present disclosure has been described with reference to exemplary embodiments, it is to be understood that the invention is not limited to the disclosed exemplary embodiments.

We claim:

1. An image processing method comprising:
acquire an image from an image capture device, the image being captured live in real-time;
acquire orientation information associated with a subject in the acquired image;
use the acquired orientation information to obtain, from an image repository, a previously captured image of the subject in a similar orientation;
generate a composite image by inpainting one or more landmarks from the obtained precapture image that are not present in the acquired live image based on a predetermined geometric representation of the subject; and
display, on a display device, the generated composite image.

2. The image processing method according to claim 1, wherein the subject in the acquired image is wearing a head mount display device that occludes at least an upper region of a face, and further comprising
generating the composite image by using, an upper region of a face in the obtained precaptured image and inpainting the live captured image.

3. The image processing method according to claim 1, wherein the geometric representation of the subject is three dimensional point cloud data of the subject in the live captured image wearing a head mount display device.

4. The image processing method according to claim 1, wherein the predetermined geometric representation is a three dimensional point cloud including a plurality of point in three dimensional space of a head of the subject wearing an head mount display device.

5. The image processing method according to claim 1, wherein the predetermined geometric representation of the subject includes information associated with one or more of scaling, rotation and translation of a head mount display being worn by the subject in the live captured image.

6. The image processing method according to claim 1, further comprising:
selecting the predetermined geometric representation from a candidate set of geometric representation of the subject.

7. The image processing method according to according to claim 1, further comprising:
updating the predetermined geometric representation of the subject for a subsequently acquired live captured image based on variation of a position of an object being worn by the subject in the acquired live capture image.

8. The image processing method according to claim 1, further comprising:
providing the acquired live capture image to a trained machine learning model that has been trained to identify positions of a predetermined object being worn by a user in an image;
generate a similarity score by evaluating a position change of the predetermined object between the live captured image and a next live captured image;
determining, based on the generated similarity scored whether to continue to use the predetermined geometric representation or update the geometric representation with a different geometric representation selected from a set of candidate geometric representations.

9. The image processing method according to claim 1, wherein the predetermined geometric representation is determined by:
obtaining a finite list of geometric representations of a subject wearing an object that occludes at least a portion of the subject
select a plurality of geometric representation of the subject wearing the object;
perform inpainting on the live captured image whereby landmarks from a precaptured image having substantially similar orientation and from a region being occluded by the object are inserted into the live captured image;
evaluate the inpainted live image using the obtained finite list to determine a similarity score; and
select, as the predetermined geometric representation, the geometric representation having a closet similarity score.

10. An information processing apparatus comprising
one or more memories storing instructions; and
one or more processors that, upon execution of the stored instructions, are configured to execute an image processing method comprising
acquire an image from an image capture device, the image being captured live in real-time;
acquire orientation information associated with a subject in the acquired image; use the acquired orientation information to obtain, from an image repository, a previously captured image of the subject in a similar orientation;
generate a composite image by inpainting one or more landmarks from the obtained precapture image that are not present in the acquired live image based on a predetermined geometric representing the subject; and
display, on a display device, the generated composite image.

11. A non-transitory computer readable storage medium storing instructions that, when executed by one or more processors of an information processing apparatus, configures the information processing apparatus to execute an image processing method comprising
acquiring an image from an image capture device, the image being captured live in real-time;
acquiring orientation information associated with a subject in the acquired image;
using the acquired orientation information to obtain, from an image repository, a previously captured image of the subject in a similar orientation;
generating a composite image by inpainting one or more landmarks from the obtained precapture image that are not present in the acquired live image based on a predetermined geometric representing the subject; and
displaying, on a display device, the generated composite image.

12. A system comprising:
a head mount display device configured to be worn by a subject;
an image capture device configured to capture real time images of the subject wearing the head mount display device; and
an apparatus configured to execute a method comprising
acquiring an image from an image capture device, the image being captured live in real-time,
acquiring orientation information associated with a subject in the acquired image;
using the acquired orientation information to obtain, from an image repository, a previously captured image of the subject in a similar orientation,
generating a composite image by inpainting one or more landmarks from the obtained precapture image that are not present in the acquired live image based on a predetermined geometric representing the subject, and
displaying, on a display device, the generated composite image.
